(19) United States
(12) Patent Application Publication
(10) Pub. No.: US 2023/0299710 A1
(43) Pub. Date: Sep. 21, 2023

(54) PHOTOVOLTAIC TRACKING SYSTEM FACILITATING SPACE UTILIZATION

(71) Applicant: LEEYOUNG S&D CO., LTD., Ansan-si Gyeonggi-do (KR)

(72) Inventors: Young Sub LEE, Gwangmyeong-si Gyeonggi-do (KR); Jin Young YOUN, Gwangmyeong-si Gyeonggi-do (KR)

(21) Appl. No.: 18/040,954

(22) PCT Filed: Aug. 18, 2021
(86) PCT No.: PCT/KR2021/010973

§ 371 Date: Feb. 7, 2023

(30) Foreign Application Priority Data
Aug. 27, 2020 (KR) 10-2020-0108369

(51) Int. Cl. H02S 20/32; G01S 19/42; G01S 19/53; G01S 19/25

(52) U.S. Cl. CPC H02S 20/32; G01S 19/42; G01S 19/53; G01S 19/258

(57) ABSTRACT

It is possible to increase power generation efficiency by optimally tracking sunlight while minimizing an installation space when compared to a facility of a two-axis rotation type by moving a PV panel in all directions by adjusting only slopes in an x-axis (horizontal axis) and a y-axis (vertical axis) of the PV panel so that the PV panel is perpendicular to incident sunlight without rotating the PV panel according to an azimuth.

### TECHNICAL FIELD

The present invention relates to a photovoltaic (PV) tracking system, and more particularly to a PV tracking system facilitating space utilization which enables increase in power generation efficiency by optimally tracking sunlight while minimizing an installation space when compared to a facility of a two-axis rotation type by adjusting slopes in an x-axis (horizontal axis) and a y-axis (vertical axis) so that a PV panel is perpendicular to an incident angle (i) of sunlight without rotating the PV panel according to an azimuth.

### BACKGROUND ART

Recently, use of PV power generation devices, which are eco-friendly energy facilities using sunlight, which is a clean energy source that does not cause environmental pollution problems while replacing fossil fuels, has been gradually increasing.

The PV power generation devices may be classified into a fixed type (fixed) PV power generation system in which a panel (PV panel) equipped with a solar cell module is fixed and a tracking type (tracking) PV power generation system that follows a trajectory of the sun.

The fixed type PV power generation system is the cheapest and requires a simple facility or structure, and thus has been installed a lot in the past. However, efficiency is lower than that of the tracking system. That is, since an angle of incidence of sunlight is wider than a vertical component of the PV panel due to a changing solar altitude and azimuth, the amount of power generation is much less than that of the tracking PV power generation system.

The tracking PV power generation system is technology having higher power generation efficiency than that of the fixed PV power generation system. This system is a power generation system that actively tracks the sun and is technology that increases the amount of power generation. The tracking type is roughly divided into an altitude/azimuth type PV power generation system that tracks an altitude and an azimuth using a PV tracking sensor, and a diurnal motion type PV power generation system, which is a motor-driven tracking system that predicts diurnal motion.

Most altitude/azimuth type tracking PV power generation systems track the sun using a two-axis rotation type that tracks an azimuth angle Zₙ and an altitude angle h of the sun to track the sun.

The two-axis rotation type is a scheme of tracking the sun by calculating the azimuth angle Zₙ and the altitude angle h at a location where the system is installed, and controlling the system so that the PV panel is rotated by the azimuth angle and is tilted toward the sun by the altitude angle h.

Calculation factors of the sun used for the two-axis rotation type are the azimuth angle Zₙ and the altitude angle h.

In the two-axis rotation type, the azimuth angle Zₙ and the altitude angle h of the sun relative to a current location are calculated, and the PV panel is rotated by the calculated azimuth angle so that the PV panel may directly face the sun. Thereafter, the panel is operated to be tilted by the altitude angle of the sun.

A calculation scheme of the azimuth angle Zₙ and the altitude angle h is as follows.

When longitude and latitude of an observer are set to (Long, Lat), and a sun position is set to (GHA, Dec), the azimuth angle Zₙ and the altitude angle h at which the observer views the sun may be expressed through a spherical triangle as illustrated in FIG. 1.

A value of an LHA (Local Hour Angle) may be obtained by the following [Equation 1]. The LHA denotes local time, and ranges from 0° to 360° westward.

LHA=GHA+Long [Equation 1]

Here, Long denotes longitude, and has a (−) value in the case of west and a (+) value in the case of east.

To calculate the azimuth angle Zₙ and the altitude angle h in FIG. 1, the following [Equation 2] may be used.

cos(90−h)=cos(90−Lat)·cos(90−Dec)+sin(90−Lat)·sin(90−Dec)·cos(LHA)

⇒ sin(h)=sin(Lat)·sin(Dec)+cos(Lat)·cos(Dec)·cos(LHA)

∴h=arcsin(sin(Lat)·sin(Dec)+cos(Lat)·cos(Dec)·cos(LHA))

cos(Zn)=(cos(90−Dec)−cos(90−Lat)·cos(90−h))/(sin(90−Lat)·sin(90−h))

⇒ cos(Zn)=(sin(Dec)−sin(Lat)·sin(h))/(cos(Lat)·cos(h))

∴Zn=arccos((sin(Dec)−sin(Lat)·sin(h))/(cos(Lat)·cos(h)))

if sin(LHA)>0,then Zn=360°−Zn [Equation 2]

Here, Dec denotes a declination of the sun.

To calculate the incident angle i, a virtual hemisphere surrounding the observer is assumed as illustrated in FIG. 2 (concept of a celestial sphere).

To describe a situation of the sunlight pouring down to the observer on a plane and the PV panel for receiving the sunlight, a hemisphere illustrated in FIG. 2 is virtually introduced. A spherical triangle may be used as such a hemisphere for interpretation thereof. Even though the spherical triangle is used, calculation of a northern hemisphere will be focused upon.

FIG. 3 illustrates that the PV panel is tilted by PV_h in an arbitrary direction PV_Zn.

A point at which the vertical component of the PV panel is in contact with the virtual sphere by PV_Zn and PV_h is referred to as PV_point.

In FIG. 4, a point at which sunlight received by the observer is in contact with a virtual circle is defined as SUN_point. At this time, the azimuth angle Zₙ and the altitude angle h of the sun have been previously calculated through a calculation formula.

The above description is summarized as follows.

Zₙ: Azimuth angle of sun at location of PV panel

h: Altitude angle of sun at location of PV panel

PV_Zₙ: Azimuth angle (direction) of PV panel

PV_h: Tilt angle of PV panel

In order to calculate the above factors by spherical trigonometry, Zₙ and PV_Zₙ may be assumed to be longitude components (0° to 360°), and h and PV_h may be assumed to be latitude components (0° to 90°).

Accordingly, when a spherical triangle is formed as illustrated in FIG. 5, it can be seen that an angular distance i between PV_point and SUN_point at this time becomes an incident angle of sunlight actually incident on the PV panel.

Here, LHA=Zₙ−PV_Zₙ, which may be expressed as the following [Equation 3] according to the spherical cosine law.

cos(90−i)=cos(90−h)·cos(PV_h)+sin(90−h)·sin(PV_h)·cos(LHA)

⇒ sin(i)=sin(h)·cos(PV_h)+cos(h)·sin(PV_h)·cos(LHA)

∴i=arcsin(sin(h)·cos(PV_h)+cos(h)·sin(PV_h)·cos(LHA)) [Equation 3]

An ultimate purpose of this action is to control the incident angle i at which sunlight is incident on the PV panel so that the incident angle i is perpendicular (90°) to a plane of the PV panel as illustrated in FIG. 6B.

Since i is the incident angle, “i=90” means that the PV panel accurately receives sunlight, and since “sin(90°)=1,” means that efficiency of the PV panel is maximized.

Therefore, in order to make the incident angle i of sunlight perpendicular to the plane of the PV panel, the two-axis rotation type is used in many instances.

As is well known, a PV tracking system of a general two-axis rotation type rotates the PV panel by the calculated azimuth angle, and then operates the PV panel to tilt the PV panel by the altitude angle of the sun so that the PV panel may directly face the sun.

At this time, in a process of transforming both the azimuth angle and the altitude angle, a disadvantage occurs in space utilization according to a radius around which the PV panel rotates. For example, in order to rotate a PV panel having a width of 3 m and a length of 4 m, a unit area corresponding to a rotation radius of 5 m which is a length of a hypotenuse is required according to the Pythagorean theorem. Therefore, when two systems need to be horizontally and consecutively installed, a horizontal length of at least 10 m is required.

As such, a tracking PV system employing a general two-axis rotation type has a disadvantage in that a large installation space is required, and as a result, site purchase costs are excessively required due to such installation space.

In particular, when economic loss in a purchase price of a power generation site occurs along with a lack of the number of facilities per unit area, selection of the two-axis rotation type may naturally act as a limiting factor in terms of a PV power generation facility.

As a result, these limitations become obstacles to widely expanding and distributing large-scale PV power generation systems by applying a highly efficient two-axis rotation type thereto.

Republic of Korea Patent Publication No. 10-2010-0119007 (hereinafter referred to as “Patent Literature”) discloses a PV tracking device that includes a calculation unit for calculating a location of the sun, and controls a yawing and a swing rotation angle of a solar cell module using a calculated altitude angle and azimuth angle of the sun.

Tracking technology applied to Patent Literature uses a two-axis rotation type in which the altitude angle and azimuth angle of the sun are calculated to control an azimuth and altitude of the solar cell module, and thus has a disadvantage in that a large system installation space is required as in a general two-axis rotation PV tracking system and has a disadvantage in that the site purchase cost, etc. is excessively required due to such an installation space.

### DISCLOSURE

### Technical Problem

Therefore, the present invention has been proposed to solve various problems occurring in a tracking PV system using a general two-axis rotation type as described above and conventional art, and it is an object of the present invention to provide a PV tracking system facilitating space utilization which enables increase in power generation efficiency by optimally tracking sunlight while minimizing an installation space when compared to a facility of a two-axis rotation type by adjusting slopes in an x-axis (horizontal axis) and a y-axis (vertical axis) so that a PV panel is perpendicular to an incident angle (i=90°) of sunlight without rotating the PV panel according to an azimuth.

### Technical Solution

In accordance with an aspect of the present invention, the above and other objects can be accomplished by the provision of a PV tracking system facilitating space utilization, the PV tracking system including
a GPS module configured to acquire current time and current location information in real time through a satellite,
an almanac database configured to provide almanac data,
a controller configured to calculate a sun position using almanac data provided by the almanac database, calculate an azimuth angle and an altitude angle using the calculated sun position and the current location information acquired through the GPS module, and generate a slope adjustment signal so that a PV panel is perpendicular to incident sunlight based on the calculated azimuth angle and altitude angle, and
a panel driving unit configured to move a horizontal axis and a vertical axis of the PV panel so that the PV panel is perpendicular to incident sunlight using the slope adjustment signal generated by the controller.

The PV panel may not rotate according to an azimuth, and only an x-axis slope in a horizontal direction and a y-axis slope in a vertical direction may be changed when the PV panel is viewed from above.

The controller may calculate the azimuth angle and the altitude angle by spherical trigonometry using an almanac in the current location information.

The controller may calculate an angle at which the PV panel tilts in an x-axis, which is a horizontal axis, and an angle at which the PV panel tilts in a y-axis, which is a vertical axis, using the calculated azimuth angle and altitude angle.

The controller may include a position-of-sun calculation unit configured to calculate a sun position using almanac data provided by the almanac database, an azimuth angle/altitude angle calculation unit configured to calculate an azimuth angle and an altitude angle using the sun position calculated by the position-of-sun calculation unit and the current location information acquired through the GPS module, a coordinate transformation unit configured to calculate an angle at which the PV panel tilts in an x-axis, which is the horizontal axis, and an angle at which the PV panel tilts in a y-axis, which is the vertical axis, based on the azimuth angle and the altitude angle calculated by the azimuth angle/altitude angle calculation unit, and a driving controller configured to output the tilting angle in the x-axis and the tilting angle in the y-axis calculated by the coordinate transformation unit as a slope adjustment signal of the PV panel.

### Advantageous Effects

According to the present invention, there is an effect of increasing power generation efficiency by optimally tracking sunlight while minimizing an installation space when compared to a PV tracking system of a two-axis rotation type by adjusting only slopes in an x-axis (horizontal axis) and a y-axis (vertical axis) so that a PV panel is perpendicular to incident sunlight without rotating the PV panel according to an azimuth.

In addition, according to the present invention, there is an advantage in that power savings may be promoted according to elimination of a rotating device since the PV panel may be rotated in all directions by adjusting a horizontal axis and a vertical axis of the PV panel and a ball joint, which is a simple means of rotation, without the need for a complicated rotating device for rotating the PV panel.

### DESCRIPTION OF DRAWINGS

FIG. 1 is an illustrative diagram of an azimuth angle and an altitude angle using a conventional spherical triangle;

FIG. 2 is an illustrative diagram of a virtual hemisphere surrounding an observer;

FIG. 3 is an explanatory diagram of a state (PV_point) in which a PV panel is tilted by an arbitrary angle in an arbitrary direction;

FIG. 4 is an explanatory diagram of a point (SUN_point) at which sunlight received by the observer is in contact with a virtual circle;

FIG. 5 is an explanatory diagram of an incident angle between sunlight and the PV panel using a spherical triangle;

FIG. 6A is an explanatory diagram of a state in which an incidence angle of sunlight (i)≠90° on the PV panel in an arbitrary direction;

FIG. 6B is an explanatory diagram of a state in which the incidence angle of sunlight (i)=90° on the PV panel;

FIG. 7 is a block diagram of a PV tracking system facilitating space utilization according to the present invention;

FIGS. 8 and 9 are illustrative diagrams each expressing, on rectangular coordinates, an azimuth angle Zₙ and an altitude angle h displayed on spherical coordinates;

FIGS. 10 and 11 are illustrative diagrams each expressing an incident angle of sunlight;

FIG. 12 is an illustrative diagram in which an incident angle of sunlight is projected on an xz plane;

FIG. 13 is a three-dimensional view of a length projected on each of an x-axis, a y-axis, and a z-axis when a length of a line segment PO is set to r;

FIG. 14A is a bird's-eye view according to rotation of two PV tracking systems of an existing two-axis driving scheme;

FIG. 14B is a bird's-eye view according to operations of two PV tracking systems according to the present invention;

FIG. 15A is an illustrative diagram of an operation of a PV panel of the existing two-axis driving scheme; and

FIG. 15B is an illustrative diagram of an operation of a PV panel according to the present invention.

### BEST MODE

Hereinafter, a PV tracking system facilitating space utilization according to a preferred embodiment of the present invention will be described in detail with reference to the accompanying drawings.

A term or word used in the present invention described below should not be construed as being limited to a common or dictionary meaning, and should be interpreted as having a meaning and concept consistent with the technical spirit of the present invention based on the principle that the inventor may appropriately define the term or word as a concept of the term in order to describe the invention in the best way.

Therefore, the embodiments described in this specification and configurations illustrated in the drawings are only preferred embodiments of the present invention, and do not represent the full technical spirit of the present invention, and thus it should be understood that there may be various equivalents and variations that may be substitutes therefor at the time of this application.

FIG. 7 is a block diagram of a PV tracking system facilitating space utilization according to a preferred embodiment of the present invention, and may include a GPS module 10, an almanac database (DB) 20, a power source 30, a controller 40, a panel driving unit 50, and a PV panel 60.

The GPS module 10 serves to obtain current time and location information in real time through a satellite, and transmit the obtained time and location information to the controller 40. A current location may be manually input to the GPS module 10 by adding a separate input means.

The almanac database 20 serves to store almanac data. The almanac data includes positional information of a celestial body according to time. In most stars and constellations, regular motion may be observed, and arrangement of the regular motion of the celestial body is referred to as almanac data. Such an almanac includes various types of information necessary for observing the celestial body, including locations of the sun, moon, planets, stars, etc.

Almanac Data annually published by the Korea Hydrographic and Oceanographic Administration may be used, or the internationally used VSOP87 may be used.

The power supply 30 serves to supply driving power using a battery, etc.

The controller 40 serves to calculate the sun position using the almanac data provided by the almanac database 20, calculate the azimuth angle Zₙ and the altitude angle h using the calculated sun position and the current location information acquired through the GPS module 10, and generate a slope adjustment signal so that the PV panel is perpendicular to the incident sunlight based on the calculated azimuth angle and altitude angle.

The controller 40 calculates the azimuth angle and the altitude angle by spherical trigonometry using the almanac from the current location information, and may calculate an angle at which the PV panel 60 tilts in an x-axis, which is a horizontal axis, and an angle at which the PV panel 60 tilts in a y-axis, which is a vertical axis, using the calculated azimuth angle and altitude angle.

To this end, the controller 40 includes a position-of-sun calculation unit 41 configured to calculate the sun position using the almanac data provided by the almanac database 20, an azimuth angle/altitude angle calculation unit 42 configured to calculate an azimuth angle and an altitude angle using the sun position calculated by the position-of-sun calculation unit 41 and the current location information acquired through the GPS module 10, a coordinate transformation unit 43 configured to calculate an angle at which the PV panel 60 tilts in the x-axis, which is the horizontal axis, and an angle at which the PV panel 60 tilts in the y-axis, which is the vertical axis, based on the azimuth angle and the altitude angle calculated by the azimuth angle/altitude angle calculation unit 42, and a driving controller 44 configured to output the tilting angle in the x-axis and the tilting angle in the y-axis calculated by the coordinate transformation unit 43 as a slope adjustment signal of the PV panel 60.

The panel driving unit 50 serves to move the horizontal axis and the vertical axis of the PV panel 60 so that the PV panel 60 is perpendicular to the incident sunlight using the slope adjustment signal generated by the controller 40.

To this end, it is considered that the panel driving unit 50 is provided with a power generating means or driving means such as a motor or an actuator, and is provided with a rotation means such as a ball joint for rotating the PV panel 60 at a center of the PV panel 60. The actuator may include a horizontal actuator (first actuator) that moves the PV panel 60 in a horizontal direction and a vertical actuator (second actuator) that moves the PV panel 60 in a vertical direction.

The PV panel 60 does not rotate according to the azimuth, and only slopes of the x-axis, which is the horizontal axis, and the y-axis, which is the vertical axis, change when viewing the PV panel 60 from above.

A detailed description of the operation of the PV tracking system facilitating space utilization according to the present invention configured as described above is as follows.

First, on the assumption that the PV panel 60 is viewed from above, the x-axis (horizontal axis) and the y-axis (vertical axis) are defined so that a (+) angle value is obtained when the x-axis is tilted in a (+) direction, and a (−) angle value is obtained in the opposite case, and so that a (+) angle value is obtained when the y-axis is tilted in a (+) direction, and a (−) angle value is obtained in the opposite case.

When driving power is supplied by the power source 30, and tracking of the PV panel 60 starts, the position-of-sun calculation unit 41 of the controller 40 calculates the sun position (GHA, Dec) by utilizing the almanac provided by the almanac database 20 at the current location acquired through the GPS module 10. Here, since a method of calculating the sun position at an arbitrary time through the almanac is the same as a method generally used in a conventional PV tracking system, a detailed description thereof will be omitted.

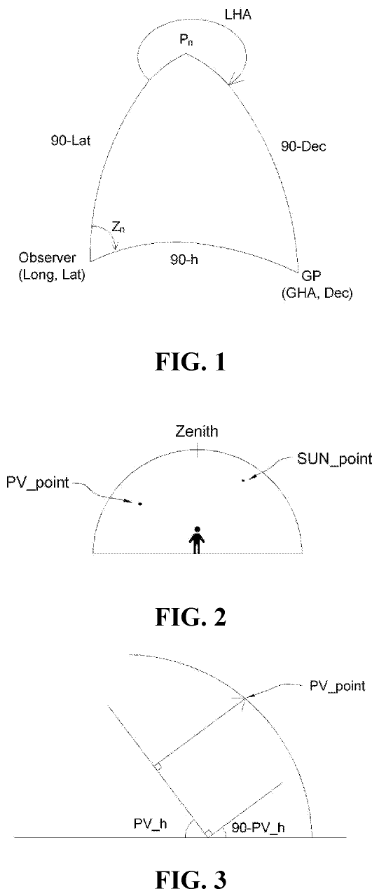

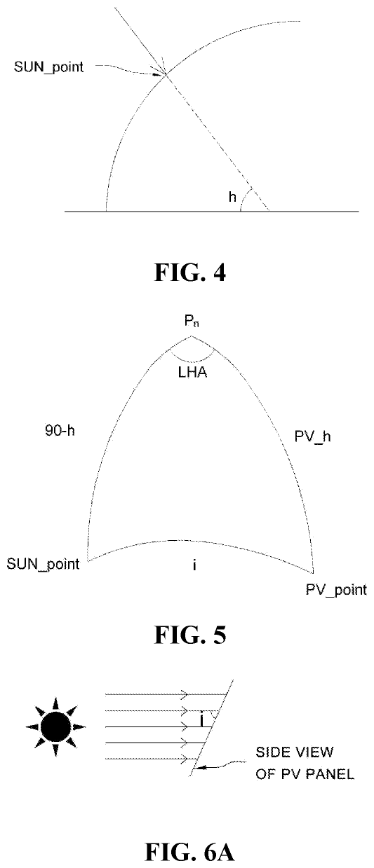

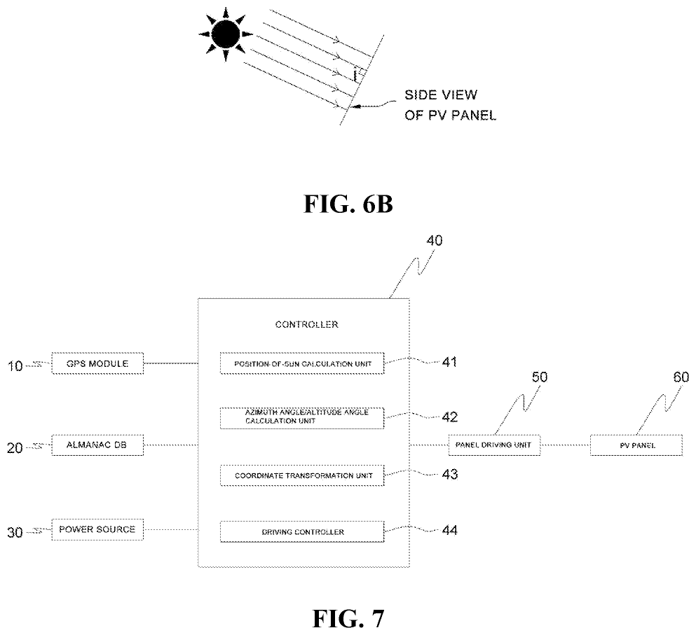

Next, the azimuth angle/altitude angle calculation unit 42 calculates the azimuth angle Zₙ and the altitude angle h using a spherical triangle illustrated in FIG. 1 by using the calculated sun position and the current location (longitude, latitude) (Long, Lat) acquired through the GPS module 10.

Subsequently, the coordinate transformation unit 43 transforms the calculated azimuth angle and altitude angle into slope values (θₓ, θ_{y}) making the PV panel 60 perpendicular to the incident sunlight as in the actual existing two-axis rotation type of the PV tracking system by moving only the horizontal axis and the vertical axis without rotating the azimuth angle of the PV panel 60.

That is, the core of the present invention is to coordinate-transform (Zₙ, h), which are the calculated azimuth angle and altitude angle, into the slope values (θₓ, θ_{y}), which are an x-axis slope in the horizontal direction and a y-axis slope in the vertical direction so that the PV panel 60 is perpendicular to the incident sunlight.

In this instance, θₓ and θ_{y} are angles, not distances. Further, smoothness of control may be maintained by coordinate-transforming (θₓ, θ_{y}) into (Zₙ, h) and monitoring an operating state of the system.

A more specific description thereof is as follows.

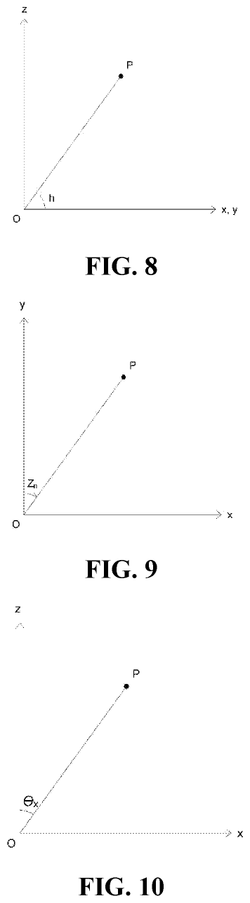

For mutual transformation from (Zₙ, h) into (θₓ, θ_{y}) and from (θₓ, θ_{y}) into (Zₙ, h), the azimuth angle Zₙ and the altitude angle h displayed on spherical coordinates as illustrated in FIGS. 8 and 9 need to be expressible in rectangular coordinates. Here, h has a range of 0° <h<90°, and Zₙ has a range of 0°<Zₙ<360°. That is, it may be considered as a general type of a two-axis rotation device.

θₓ and θ_{y} denote angles tilted in the x-axis and the y-axis, respectively, with respect to the z-axis as illustrated in FIG. 8. Therefore, both θₓ and θ_{y} have ranges of −90°<θₓ<90° and −90°<θ_{y}<90°, and the unit is [°] (degree).

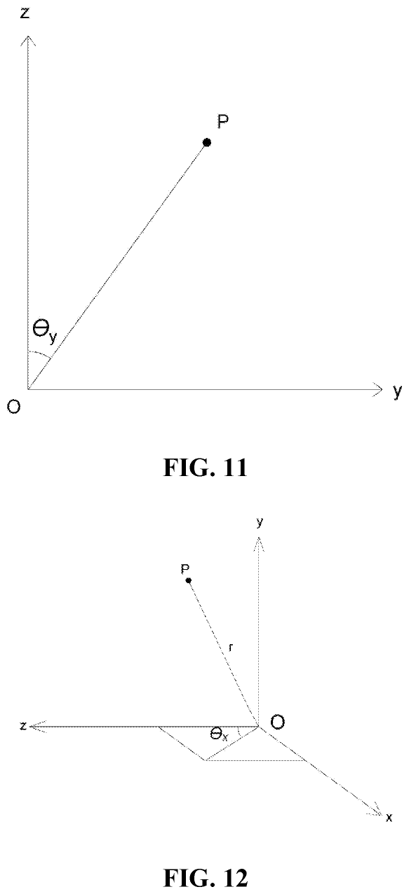

In FIGS. 10 and 11, a line segment PO represents incident sunlight. That is, it is assumed that sunlight is incident from P to O.

FIG. 12 illustrates that the line segment PO is projected on an xz plane.

When a length of the line segment PO is set to r, and projected lengths of the line segment PO on the x-axis, y-axis, and z-axis are set to rₓ, r_{y}, and r_{z}, respectively, rₓ, r_{y}, and r_{z} may be represented by [Equation 4].

rₓ=r·cos(h)·sin(Zn)

r_{y}=r·cos(h)·cos(Zn)

r_{z}=r·sin(h) [Equation 4]

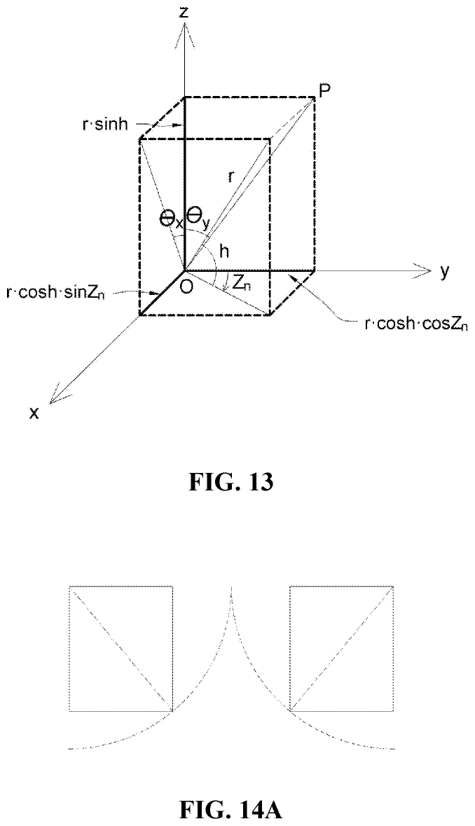

When the above formulae are expressed on a three-dimensional surface, the formulae may be expressed as illustrated in FIG. 13.

In FIG. 13, θₓ projected on the zx plane may be expressed as the following [Equation 5].

tan(θₓ)=rₓ/r_{z}=(r·cos(h)·sin(Zn))/(r·sin(h))

∴θₓ=arctan(sin(Zn)/tan(h)) [Equation 5]

In order to obtain θ_{y} projected on the zx plane, θ_{y} may be expressed as the following [Equation 6].

tan(θ_{y})=r_{y}/r_{z}=(r·cos(h)·cos(Zn))/(r·sin(h))

∴θ_{y}=arctan(cos(Zn)/tan(h)) [Equation 6]

Meanwhile, in the above [Equation 5] and [Equation 6], the azimuth angle Zn and altitude angle h may be obtained through θₓ and θ_{y}.

When tan(h) is commonly calculated in the above [Equation 5] and [Equation 6], [Equation 7] may be obtained.

tan(θₓ)=sin(Zn)/tan(h),tan(θ_{y})=cos(Zn)/tan(h)

sin(Zn)/tan(θₓ)=cos(Zn)/tan(θ_{y})

⇒ tan(Zn)=tan(θₓ)/tan(θ_{y})

∴Zn=arctan(tan(θₓ)/tan(θ_{y})) [Equation 7]

In the above [Equation 7], to accurately calculate Zₙ,

if θ_{y}<0,Zₙ=Zₙ+180

When [Equation 5] and [Equation 6] are calculated again, the following [Equation 8] may be obtained.

sin(Zn)=tan(θₓ)·tan(h),cos(Zn)=tan(θ_{y})·tan(h)

sin²(Zn)+cos²(Zn)=1

⇒ tan²(θₓ)·tan²(h)+tan²(θ_{y})·tan²(h)=1

⇒ tan²(h)=1/(tan²(θₓ)+tan²(θ_{y}))

∴h=arctan(1/(tan²(θₓ)+tan²(θ_{y}))^{1/2}) [Equation 8]

When formulae of the above [Equation 5] and [Equation 6] are arranged, coordinate transformation shown in [Equation 9] below is possible.

(Zn,h)⇒(θₓ,θ_{y})

θₓ=arctan(sin(Zn)/tan(h)),θ_{y}=arctan(cos(Zn)/tan(h)) [Equation 9]

(Zₙ, h), which are the azimuth angle and the altitude angle calculated through this process, are coordinate-transformed into slope values (θₓ, θ_{y}), which are the x-axis slope in the horizontal direction and the y-axis slope in the vertical direction making the PV panel 60 perpendicular to incident sunlight.

Subsequently, the driving controller 44 calculates a slope value for performing a control operation so that the PV panel 60 is perpendicular to incident sunlight and a current slope value of the PV panel, and extracts a difference therebetween. Here, the calculated slope values (θₓ, θ_{y}) may be used without change. However, in this case, control needs to be performed after setting a position of the PV panel 60 to an initial state (horizontal state) at all times. Therefore, a lot of control time of the PV panel 60 is required, and complexity increases.

Therefore, in the present invention, the driving controller 44 stores a previous slope value calculated immediately before (meaning current horizontal and vertical slope values of the PV panel) in an internal memory, and calculates the previous slope value stored in the internal memory and a currently calculated new slope value and outputs a difference therebetween as a slope control signal to the panel driving unit 50 only when the new slope value is generated.

As another method, a time clock provided by the driving controller 44 is used to store a slope value calculated at any time in an internal memory, a previous slope value stored in the internal memory and a new slope value calculated at a current time are calculated after a certain time has elapses, and a difference thereof is output as a slope control signal to the panel driving unit 50.

The slope control signal output in this way determines the amount of rotation of a motor or the amount of movement of an actuator. Here, the slope control signal is an x-axis slope control signal in the horizontal direction and a y-axis slope control signal in the vertical direction.

The panel driving unit 50 adjusts the x-axis slope in the horizontal direction and the y-axis slope in the vertical direction of the PV panel 60 using the motor or the actuator according to the transmitted slope control signals. Referring to FIG. 15B, the x-axis slope in the horizontal direction of the PV panel 60 is adjusted using a first actuator 53, and the y-axis slope in the vertical direction of the PV panel 60 is adjusted using a second actuator 52. Although not illustrated in the figure, a rotation means such as a known ball joint is provided at a portion where a mount 51 and the PV panel 60 are connected to each other, and thus the PV panel 60 actually rotates in all directions (360°). Accordingly, the PV panel 60 becomes perpendicular to the incident sunlight, and optimal power generation efficiency may be obtained.

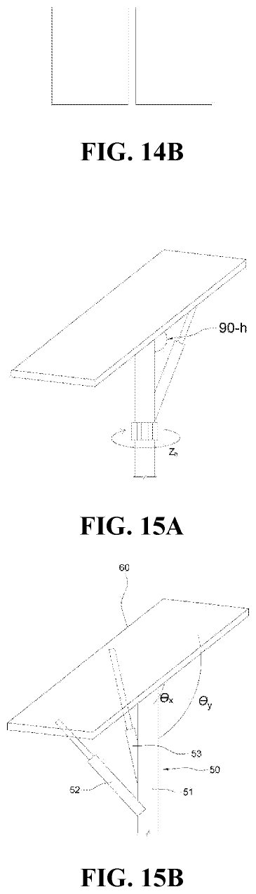

FIG. 14A is a bird's-eye view according to rotation of two PV tracking systems to which an existing two-axis driving scheme is applied, and FIG. 15A is an illustrative diagram of a driving scheme of a PV panel in a PV tracking system to which the existing two-axis driving scheme is applied.

As illustrated in FIG. 14A, the two PV tracking systems to which the existing two-axis driving scheme is applied require a large installation space since a surrounding rotational space needs to be ensured according to rotation of the azimuth angle Zₙ as illustrated in FIG. 15A. Therefore, the two PV tracking systems of the existing two-axis driving scheme need to have arrangement ensuring a rotational space as in FIG. 14A.

FIG. 14B is a bird's-eye view according to operations of two PV tracking systems according to the present invention, and FIG. 15B is an illustrative diagram of a driving scheme of a PV panel in a PV tracking system to which the present invention is applied.

Since the present invention does not requires a rotational space of the azimuth angle Zₙ as illustrated in FIG. 14B, first and second PV tracking systems may be installed adjacent to each other, and thus it can be seen that space utilization is significantly high.

Meanwhile, as another feature of the present invention, the controller 40 may constantly monitor whether the system is properly tracking a desired azimuth angle and altitude angle by coordinate-transforming the calculated tilt angle in the x-axis and the calculated tilt angle in the y-axis through [Equation 10]. In this instance, [Equation 10] below is a summary of [Equation 7] and [Equation 8].

(θₓ,θ_{y})⇒(Zn,h)

Zn=arctan(tan(θₓ)/tan(θy)),

if θ_{y}<0,thenZₙ=Zₙ+180

h=arctan(1/(tan²(θₓ)+tan²(θ_{y}))^{1/2}) [Equation 1θ]θ

As described in detail above, the present invention may optically track the sun only by adjusting x-axis (horizontal axis) and y-axis (vertical axis) slopes so that the PV panel is perpendicular to the incident sunlight without rotating the PV panel according to the azimuth, and thus may increase power generation efficiency by optically tracking the sunlight while minimizing an installation space when compared to the PV tracking system of the two-axis rotation type.

In addition, according to the present invention, the PV panel may be moved to face a desired point by adjusting only the simple rotation means such as the ball joint and the horizontal axis and the vertical axis of the PV panel without the need for a complicated rotation device for rotating the PV panel, and thus it is possible to achieve power saving due to reduction in the number of rotation devices.

Even though the invention made by the present inventors has been specifically described according to the above embodiments, the present invention is not limited to the above embodiments, and it is obvious to those skilled in the art that various changes may be made without departing from the gist.

### REFERENCE SIGNS LIST

10: GPS module
20: Almanac DB
30: Power source
40: Controller
41: Position-of-sun calculation unit
42: Azimuth angle/altitude angle calculation unit
43: Coordinate transformation unit
44: Driving controller
50: Panel driving unit
60: PV panel

1. A photovoltaic (PV) tracking system facilitating space utilization, the PV tracking system comprising:
a GPS module configured to acquire current time and current location information in real time through a satellite or allow manual input of a current location;
an almanac database configured to provide almanac data;
a controller configured to calculate a sun position at a desire time using almanac data provided by the almanac database, calculate an azimuth angle and an altitude angle using the calculated sun position and the current location information acquired through the GPS module, and generate a slope adjustment signal so that a PV panel is perpendicular to incident sunlight based on the calculated azimuth angle and altitude angle; and
a panel driving unit configured to move a horizontal axis and a vertical axis of the PV panel so that the PV panel is perpendicular to incident sunlight using the slope adjustment signal generated by the controller.

2. The PV tracking system according to claim 1, wherein the panel driving unit changes an x-axis slope in a horizontal direction and a y-axis slope in a vertical direction when the PV panel is viewed from above, and the controller calculates each of an angle at which the PV panel is tilted in an x-axis, which is the horizontal direction, and an angle at which the PV panel is tilted in a y-axis, which is the vertical direction, using the calculated azimuth angle and altitude angle by using the following coordinate transformation:
(Zn,h)⇒(θₓ,θ_{y})
θₓ=arctan(sin(Zn)/tan(h)),θ_{y}=arctan(cos(Zn)/tan(h))
where Zₙ denotes an azimuth angle, h denotes an altitude angle, θₓ denotes an x-axis slope in the horizontal direction, and θ_{y} denotes a y-axis slope in the vertical direction.

3. The PV tracking system according to claim 1, wherein the controller calculates the azimuth angle and the altitude angle by spherical trigonometry using an almanac in the current location information.

4. The PV tracking system according to claim 1, wherein the controller calculates an angle at which the PV panel tilts in an x-axis, which is a horizontal axis, and an angle at which the PV panel tilts in a y-axis, which is a vertical axis, using the calculated azimuth angle and altitude angle.

5. The PV tracking system according to claim 4, wherein the controller calculates each of the angle at which the PV panel tilts in the x-axis, which is the horizontal axis, and the angle at which the PV panel tilts in the y-axis, which is the vertical axis, using the calculated azimuth angle and altitude angle by using the following Equation:
(Zn,h)⇒(θₓ,θ_{y})
θₓ=arctan(sin(Zn)/tan(h)),θ_{y}=arctan(cos(Zn)/tan(h))

6. The PV tracking system according to claim 4, wherein the controller constantly monitors whether the system is properly tracking a desired azimuth angle and altitude angle by inversely calculating the calculated tilting angle in the x-axis and tilting angle in the y-axis according to the following Equation:
(θₓ,θ_{y})⇒(Zn,h)
Zn=arctan(tan(θₓ)/tan(θ_{y})),
if θ_{y}<0,then Zₙ=Zₙ+180
h=arctan(1/(tan²(θₓ)+tan²(θ_{y}))^{1/2})

7. The PV tracking system according to claim 1, wherein the controller comprises:
a position-of-sun calculation unit configured to calculate a sun position using almanac data provided by the almanac database;
an azimuth angle/altitude angle calculation unit configured to calculate an azimuth angle and an altitude angle using the sun position calculated by the position-of-sun calculation unit and the current location information acquired through the GPS module;
a coordinate transformation unit configured to calculate an angle at which the PV panel tilts in an x-axis, which is the horizontal axis, and an angle at which the PV panel tilts in a y-axis, which is the vertical axis, based on the azimuth angle and the altitude angle calculated by the azimuth angle/altitude angle calculation unit; and
a driving controller configured to output the tilting angle in the x-axis and the tilting angle in the y-axis calculated by the coordinate transformation unit as a slope adjustment signal of the PV panel.
